(19) United States
(12) Patent Application Publication
(10) Pub. No.: US 2017/0256886 A1
(43) Pub. Date: Sep. 7, 2017

(54) ELECTRICAL CONNECTORS

(71) Applicant: IFPL Group Limited, Newport, Isle of Wight (GB)

(72) Inventors: Geoffrey Paul UNDERWOOD, Isle of Wight (GB); Mark Tyler REED, Isle of Wight (GB)

(21) Appl. No.: 15/508,007

(22) PCT Filed: Sep. 14, 2015
(86) PCT No.: PCT/GB2015/052659

§ 371 Date: Mar. 1, 2017

(30) Foreign Application Priority Data
Sep. 12, 2014 (GB) 1416180.6

(51) Int. Cl. H01R 13/62; H01R 24/58; H01R 24/76; H01R 24/28

(52) U.S. Cl. CPC H01R 13/6205; H01R 24/28; H01R 24/58; H01R 24/76; H01R 2103/00

(57) ABSTRACT

A plug (1) for electrical equipment comprising a housing (9) and two electrical pins (4, 5) extending from the housing for receipt by a socket and for electrical connection therewith, and the plug further comprising an electrical contact (3) also arranged for electrical contact with the socket, wherein the pins are longer than the electrical contact, wherein the projections arranged to facilitate disengagement of the plug from a socket, and further wherein the electrical contact arranged to magnetically attract to the socket and thereby provide a magnetic retaining force between the plug and the socket.

### TECHNICAL FIELD

The present invention relates generally to electrical connectors, and in particular, although not exclusively, to plugs and jacks for use with electrical equipment, such as headsets.

### BACKGROUND

Jack and plug connectors are known to enable a user equipment, such as headphones, to be connected to a host equipment, such as a passenger entertainment system. Whilst the plug is inserted in the jack it is possible that the user will move the headphones relative to the point of connection between the plug and the jack. If the user attempts to move the headphones beyond the length of the cable (which connects the plug to the headphones) a force will be applied to the plug and the jack by the cable. This means that cable, the jack and/or the plug could be damaged as a result of the force applied.

We have realised that it would be advantageous to provide an improved electrical connector.

### SUMMARY

According to the invention there is provided an electrical plug and an electrical socket.

The plug and/or socket may comprise one or more features in the detailed description and/or in the drawings.

### BRIEF DESCRIPTION OF THE DRAWINGS

Various embodiments of the invention will now be described, by way of example only, with reference to the following drawings in which:

FIGS. 1A and 1B are perspective views of a plug and socket arrangements,

FIG. 2 is a plan view of a plug and a socket, and

FIG. 3 is a plan view of a plug and socket

### DETAILED DESCRIPTION

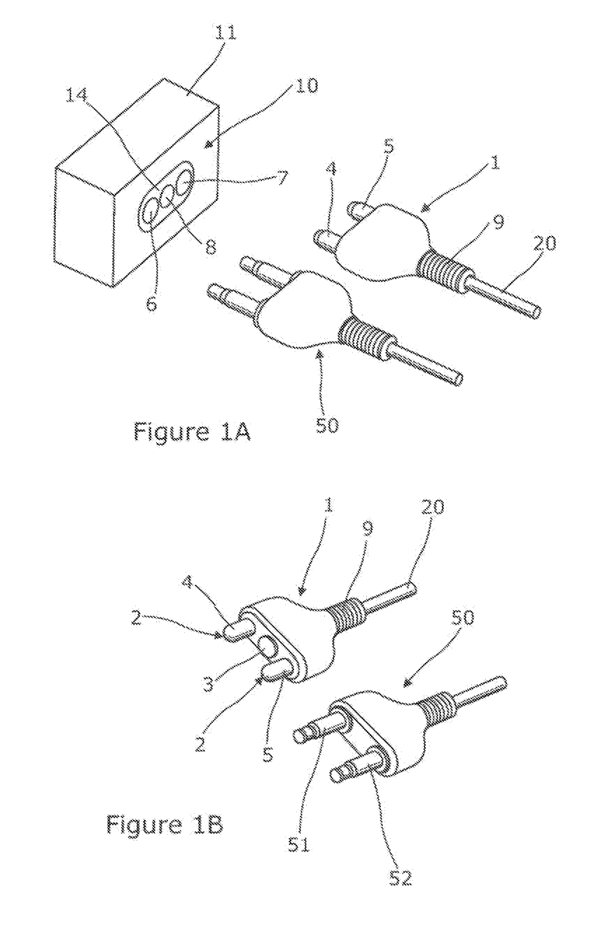

With reference to FIGS. 1A and 1B, there is shown a plug 1 for electrical equipment comprising a housing, and two pins 4 and 5, extending front and front side of the housing. As will be described below, the plug is advantageously arranged to facilitate ease of removal from a socket/jack 10. Of particular advantage is the fact that in the event that the user (for example the wearer of an audio headset connected to the plug) moves beyond the length of the cable 20 connecting the equipment to the plug, the plug can easily break away from its mating, in a quick-release manner, without causing damage to the plug or the socket.

Each of the pins 4 and 5 provides an electrical contact for connection to respective contacts in the socket 10. The plug 1 is connected to a headphone apparatus wherein each pin provides left and right audio signals respectively.

An electrical contact 3, also provided on the front surface of the plug 1, is of squat profile. The electrical contact 3 provides an electrical return contact. The contact may be viewed as a short return or audio return. The contact 3 is of substantially shorter length than the pins 4 and 5, and may be considered as having only negligible length as compared to the pins 4 and 5. The contact 3 has substantially negligible length and comprises a flat metal plate (and being magnetically attractive to a magnet) located intermediate of the pins 4 and 5.

It will be appreciated that the pins 4 and 5 are of shorter length as compared to those on a standard plug, such as the ARINC 628 standard. This, at least in part, assists removal of the plug from the socket. It is also to be noted that the distal ends or tips 2 of the each of the pins is rounded, and thereby further facilitating extraction of the pins from the socket 10. It will be appreciated however that the tips could be of a pointed construction as opposed to rounded.

The socket 10, or jack unit, comprises a housing 11, arranged to fit into a standard (or non-standard) aircraft aperture for an inflight passenger entertainment system. The housing 11 comprises a plug interface region which is arranged to interface with the plug 1. The interface region comprises two apertures 6 and 7. The apertures 6 and 7 are arranged to receive respective pins 4 and 5 of the plug. An electrical contact arrangement is provided within each aperture and each is arranged to contact with a respective conductive portion of each pin, and provide suitable electrical signals thereto.

The socket 10 further comprises an electrical contact which comprises a magnet 8 which is located substantially centrally of the apertures 6 and 7. The magnet 8 is embedded in the forward surface of the socket. The magnet serves, in use, to provide a retaining force to assist in retaining the plug in a connected condition with the socket. However, the retaining force provided by the magnetisation is not so large as to prevent the plug from being disengaged from the audio jack socket. The electrical contact provides a common audio return for the plug 1, and is arranged to electrically interface with electrical contact 3 of the plug. It will be appreciated that although the magnetic contact 8 could be a (ferrous) magnetised piece of electrically conductive material, in other embodiments it may comprise a two part construction, comprising a first portion which is electrically conductive and intended to conduct electrical signals and a second part which is a magnetic, in which the first portion serves primarily to conduct electric signals and the second part serves to provide the magnetic attraction. For example the first portion may be a centrally located and the second portion being of annular shape surrounding the first portion or vice versa.

The apertures 6 and 7, and the magnetised electrical contact 8 are set in an electrically insulative portion 14, which maintains those features electrically insulated from each other.

The plug 1 is connected to an audio headset by way of a cable 20.

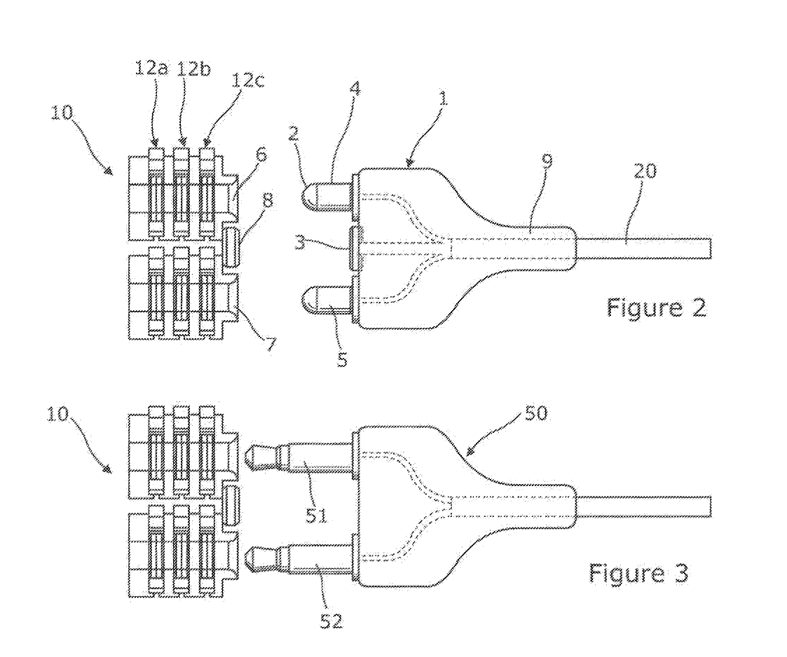

The socket 10 comprises electrical cable/wiring which connects to a source of audio signals from an on-board passenger entertainment system. Inside each of the apertures 6 and 7 there are provided a number of electrical terminals, spaced along the lengths of the recessed regions in the socket, and arranged to contact with respective contact regions of pins of an electrical plug. As can be seen in FIG. 2, each of the electrical contacts inside the socket is shown by reference numerals 12a, 12b and 12c, which are spaced along the depth of each of the respective parts of the socket. The contacts are arranged to contact with different conductive portions of plugs inserted therein, dependent on the length of the pin(s). It can also be seen from FIG. 2, as shown in broken line, the wiring within the housing of the plug to each of the pins 4 and 5 and to the contact 3.

In use, the socket 10 is installed in or adjacent to passengers' seating in an aircraft. Should the passenger wish to use the onboard entertainment system, he can push the plug 1 (of his audio headset) into the socket 10. In so doing, the pins 4 and 5 are received in the respective apertures 6 and 7, and the return contact 3 is received (in electrical connection) with the magnetised electrical contact 8 in face-to-face contact. A magnetic attraction force exists between the socket and the plug. This ensures that whilst in use the plug 1 is maintained connected to the socket 10. In the event that the user inadvertently, whilst wearing the headset, moves beyond the length of the cable, this will cause a pulling force to be applied to the plug 1. This may come about as a result of the user attempting to get up out of his seat, but forgetting to remove the headset before doing so. With conventional plugs this would result in potentially damaging forces being applied to both the headset and the plug since the plug would be retained in the socket. Moreover, with the plug 1, the lengths of the pins 4 and 5 received by the socket, and the strength of the magnetic retaining force, are such that when such a pulling force is applied to the plug, the plug is disengaged from the socket, in a quick-release manner, and thereby minimising the potentially damaging forces which could be applied. Advantageously, even if the pulling force is applied at a high angle to the plug (and thereby reducing the pulling force/vector component), the plug will nevertheless become disengaged. The quick-release process is assisted by the effective length of cable entry sleeve 9, which causes a leverage to be applied to the plug, thereby further facilitating the disengagement. The cable entry sleeve 9 may be of semi-rigid or flexible construction.

Advantageously, the socket 10 is backwards compatible in that it is capable of also allowing a known plugs (with electrical pins) to be used therewith, for example of the type which comprise a pin in which the various terminals are spaced along the length of the pin (and electrically isolated from each other). On insertion of such a known plug type, the, or each, of the terminals of the (known) pin will contact a respective terminal contact located internally of the apertures. The socket 10 therefore has the versatility to accept the plug 1, or a known plug type, and so is not restricted to use of the former. By way of example, FIG. 3 shows a known ‘standard’ two-pin plug 50, in which each of the two pins 51 and 52 thereof comprises two electrical contacts (a sleeve contact and a tip contact, electrically insulated from each other). Advantageously, the socket 10 is capable of receiving such a plug, and being fully operational therewith. The socket 10 is also compatible with single pin plugs (such as a 3.5 mm stereo plug). In order to achieve this multi-plug compatibility, the wiring of the terminals within the socket is arranged so that signals from multi-contact pins (be they of a single pin plug or a two pin plug) are correctly routed.

Although the above embodiment finds particular application in the field of headphones (and is of particular advantage in the field of (inflight or otherwise) passenger entertainment), modified embodiments also find application in relation to plug and socket arrangements for transmission of data generally, or indeed any electrical signal, and not solely audio signals and/or power. This may be achieved by providing a connection between at least two of the contacts of each aperture of the socket so that electrical signals are correctly routed for each of the different plug types which are compatible with the socket 10.

1. A plug for electrical equipment comprising a housing and two electrical pins extending from the housing for receipt by a socket and for electrical connection therewith, and the plug further comprising an electrical contact also arranged for electrical contact with the socket, wherein the pins are longer than the electrical contact, wherein the pins are arranged to facilitate disengagement of the plug from a socket, and further wherein the electrical contact is arranged to magnetically attract to the socket and thereby provide a magnetic retaining force between the plug and the socket.

2. The plug of claim 1, wherein the electrical contact is substantially flat.

3. The plug of claim 1, wherein the electrical contact is of substantially negligible length.

4. The plug of claim 1, wherein the electrical pins are substantially the same length.

5. The plug of claim 1, wherein the electrical contact comprises a metal plate.

6. The plug of claim 1, wherein the electrical contact is arranged to provide a face-to-face connection with the socket.

7. The plug of claim 1, wherein the electrical contact is arranged to provide a return signal connection.

8. An electrical socket comprising a magnetised electrical contact which provides an electrical connection for an electrical plug, the magnetised electrical contact being arranged to interface with an electrical contact of the plug, and said magnetised electrical contact being arranged to provide a magnetic retaining force to the plug when attached to the socket, as well as providing an electrical connection to the plug.

9. The electrical socket of claim 8, wherein the magnetised electrical contact comprises a substantially flat surface arranged to interface with the plug.

10. The electrical socket of claim 8, wherein the magnetised electrical contact is arranged to provide an electrical return path to the plug.

11. The electrical socket of claim 8, wherein the magnetised electrical contact comprises a metal plate.

12. The electrical socket of claim 8, further comprising two spaced-apart electrical pin receiving apertures.

13. The electrical socket of claim 8, wherein the plug comprises a housing and two electrical pins extending from the housing for receipt by the socket and for electrical connection therewith, wherein the electrical contact of the plug is arranged for electrical contact with the socket, wherein the pins are longer than the electrical contact of the plug, wherein the pins are arranged to facilitate disengagement of the plug from the socket, and further wherein the electrical contact of the plug is arranged to magnetically attract to the magnetised electrical contact of the socket and thereby provide a magnetic retaining force between the plug and the socket.

14. The electrical socket of claim 13, wherein the electrical socket is arranged to be compatible with a two-pin electrical plug and a single pin electrical plug.

15. (canceled)

16. (canceled)
